(19) United States
(12) Patent Application Publication
(10) Pub. No.: US 2003/0126228 A1
(43) Pub. Date: Jul. 3, 2003

(54) System and method for interruption-free file access

(75) Inventor: Kuang-Ming Chen, Yeong Ho (TW)

Correspondence Address: Mitchell P. Brook, Baker & McKenzie, 12th Floor, 101 West Broadway, San Diego, CA, 92101-3890, US

(73) Assignee: Lager Interactive, Inc.

(21) Appl. No.: 10/043,499

(22) Filed: Jan. 10, 2002

(30) Foreign Application Priority Data
Dec. 31, 2001 (TW) 90133337

(51) Int. Cl. G06F 15/16

(52) U.S. Cl. 709/217; 711/167

(57) ABSTRACT

An information service system for providing interruption-free information access service is disclosed to serve multiple users communicating to the system via a communications network. The system comprises a main program subsystem, an information access agent subsystem and an information storage subsystem. The main program subsystem executes a main program for providing information access service to the users by receiving user-issued I/O access requests. The information storage subsystem stores information required for implementing the information service. The I/O access agent subsystem processes user-issued I/O access requests by registering the requests received by the main program subsystem and submits the received requests to the information storage subsystem for implementing the read or write accesses corresponding to the requests. The I/O access agent subsystem relays the result of the requests to the main program subsystem for returning to the users upon completion of the submitted requests. The system continues services to user even when I/O access services are pending their corresponding results.

### FIELD OF THE INVENTION

This invention relates in general to a system and method for implementing file access service free from interruption and, in particular, to a system and method for providing such service to a large number of clients simultaneously seeking information service via a wide area network.

### BACKGROUND OF THE INVENTION

As a result of increased popularity of the Internet, network services offered by the industry aimed at providing simultaneous service to a vast number of users become ever popular. Large number of users scattered all around who are subscribed and connected to the server system of the same information service provider via a wide area network (WAN) present a unique phenomenon of network activity as they access the service simultaneously. The network activities concentrated on the server system of the service provider are characterized by the vastly diversified file access operations directed to various files in the system storage. Such accesses include both the read-out and write-in of information files originated by the different requirements of each of the accessing users.

Server systems installed in many information service organizations are required to handle heavy, sometimes extremely heavy, access loads originated by the clients they serve. Internet-based stock brokerage service provided by security houses, Internet access service by Web portals, various services by different ISP (Internet Service Provider), and on-line gaming hosted by on-line game service companies are typical examples of network services that provide simultaneous access service to hundreds of thousands of users. At a popular ISP, for example, up to several million accesses per second is possible. To satisfy these high access rates, adequate file access management system is necessary. Without managed high-efficiency access service, either customers are likely to be lost due to slow service or huge investment are required to keep up with the growing service demand. Lost customers represent lost business while investments on inefficient hardware and/or software eat away profits. Therefore, the removal of access bottlenecks in the network information service industry becomes one of the most important issues for healthy and prosperous business operation.

For instance, at a major news event, vast number of viewers rush to news websites to access the news details. In these accesses to a news website, it can be expected that news information downloads greatly out-number the upload of readers' opinions. As another example, consider the situation in which crowds of players log into an on-line game hosting company to participate in the same game in non-office hours. Relatively heavy upload accesses to the game server system as compared to the game information download accesses can be expected as the game unfolds for each of the individual players. In the case of news access, more people read news than those post comments. However, in the case of on-line game, the upload accesses for game information in relation to each of the participating player are much more intense than uploading of reader opinion in news websites. This is because a fascinating on-line game involving the participation of tens of thousands of players has to reflect the particulars of each individual player concerning his or her action, location and other parameters. In general, complexity of a game can be translated into attractiveness to players since dull games are not likely to be fascinating.

Conventionally, efficiency of file read accesses to disk storage in a computer system can be substantially improved utilizing techniques including disk caching and proxy service. However, information writing to the disk storage system, in general, do not enjoy these or similar techniques. Write caching is possible but at substantial risks. For maximum data integrity, all data are written into the storage subsystem immediately. Hardware writing operation for a specific piece of information into a disk-based storage system takes substantially longer time than reading it. This has been an inherent characteristic for modem magnetic disk-based storage equipment. As a result, the more frequent the data writing operation is in a database server, the larger bandwidth is required against the data bus channel where the storage system resides in the computer system. This is particularly the case for applications such as on-line game hosting. As mentioned, the more fascinating the game is, the more write accesses are expected in the system.

Thus, pace of the main program running on a server system frequently becomes sluggish when there are a vast number of users requesting information access simultaneously. On some occasions, execution of the main program even becomes completely stalled. Modern computer systems devote relatively less time in the computation-related processing as the central processing units become more powerful and operate at increased clock rates. In contrast, time required for the information I/O in the disk-based storage subsystems becomes the bottleneck of the entire operation. A disk-intensive application is certain to take more time to complete than one that requires less disk accesses. Mechanical head movements in a disk drive take significantly more time than the CPU performing arithmetic and logic operations.

Meanwhile, although magnetic disk-based storage devices have been advancing in terms of storage density and thus increased storage capacity, however, average access times, both read and write, in these devices have not been improved in parallel. Limitation to the speed of mechanical movements becomes the constraining barrier for disk performance improvements. Thus, the issue of how the penalty to system overall operation speed caused by frequent disk accesses can be reduced has become one of the primary considerations for the improvement of overall system performance.

For example, consider again the situation in which thousands of players participate simultaneously in an on-going on-line game episode. As the story of the game unfolds, each player submits his or her respective status parameters and retrieve his or her required information based on what the player's role and where the character is situated in the virtual game environment. All these parameter submission and information retrieval are implemented via disk write and read accesses respectively in the game-hosting server system. If, for example, due to the overwhelming number of players logged in and participating simultaneously in the game as frequently is the case, the pace of game story development becomes sluggish or even stalled occasionally as a result of the intensive disk accesses taking place in the system. Quality of the game suffers as a result and less fun of game participation can be appreciated. Therefore, the question of how these sluggishness caused by the inevitable heavy disk accesses can be reduced or even removed is one of the most important service quality factors for an on-line game hosting company.

For applications such as database information access, screen display stalls do not necessarily imply inconvenience for retrieval of the desired information. However, reduction of the occurrences of display sluggishness and/or stall in display screen, especially graphical user interface (GUI) screens, is beneficial. Removal of display sluggishness and/or stall implies improved overall system performance, which is welcome by both the user and the information service provider.

FIG. 1 is a simplified block diagram schematically showing how a main program 120 of an information service system 100 according to prior art interacts with its storage subsystem 140. In the conventional software system, the main program 120 implements direct interface with the storage subsystem 140 of the system hardware whenever an information I/O is required. Such an approach is direct and simple, but waiting periods are inevitable for I/O accesses involving substantial amounts of information. Length of the waiting period grows proportionally with the amount of information accessed. If the waiting amounts up to a length noticeable to the user of the program, smoothness of program pace becomes jeopardized. For a user, it appears to be a program interruption. During the waiting period, however, the CPU of the system is frequently left unoccupied except to idle and wait for the I/O access to complete.

FIG. 3 is a flowchart illustrating the process flow implementing a prior-art method for providing simultaneous services to multiple users. If such a scheme is employed to service hundreds or even thousands of simultaneous users, program execution stalls are inevitable and frequently unacceptable for users. This is because each implemented I/O access (positive result of the test step 330) as a result of the request of any of the users will incur a waiting phase (step 340). Program execution halts for an I/O access until the accessed result is obtained. When the number of I/O access requests are excessive, the service quality becomes degraded seriously. Costly measures of purely promoting storage equipment performance does not resolve the problem.

One of the few applicable approaches conventionally known for tackling this problem is to throw in high-level server systems at premium costs to improve hardware performance. Powerful but expensive server systems can certainly perform their assigned tasks faster than cheaper ones, however, hardware capabilities are limited. Raw speed can still be overwhelmed by large number of simultaneous accesses pouring in from all over the network. Therefore, it is desirable to have a simple and easy method for removing information access bottlenecks in network-based information service systems that can be implemented utilizing inexpensive hardware.

### SUMMARY OF THE INVENTION

The present invention provides an information service system for providing interruption-free information access service for servicing multiple users communicating to the system via a communications network. The system comprises a main program subsystem, an information access agent subsystem and an information storage subsystem. The main program subsystem executes a main program for providing information access service to the users by receiving user-issued I/O access requests. The information storage subsystem stores information required for implementing the information service. The I/O access agent subsystem processes user-issued I/O access requests by registering the requests received by the main program subsystem and submits the received requests to the information storage subsystem for implementing the read or write accesses corresponding to the requests. The I/O access agent subsystem relays the result of the requests to the main program subsystem for returning to the users upon completion of the submitted requests. The system continues services to user even when I/O access services are pending their corresponding results.

The present invention further provides a method for providing interruption-free file access service to users communicating to an information service via a communications network in an information service system comprising a main program subsystem, an information storage subsystem and an I/O access agent subsystem. The method comprises the steps of: a) the main program subsystem registering information access requests issued by users in a list and submitting the requests to the I/O access agent subsystem; b) the I/O access agent subsystem submits the requests issued by users to the information subsystem for implementing read or write accesses corresponding to the requests; and c) the I/O access agent subsystem relays the result of the requests to the main program subsystem for returning to the users upon completion of access of the submitted requests by the information storage subsystem, wherein the information service system continues information service for users even when an I/O access is pending.

### BRIEF DESCRIPTION OF THE DRAWINGS

Other objects, features and advantages of the present invention will become apparent by way of the following detailed description of the preferred but non-limiting embodiments. The description is made with reference to the accompanied drawings in which:

FIG. 1 is a simplified block diagram schematically showing how a main program in a prior-art system interacts with its storage subsystem;

FIG. 2 is another simplified block diagram schematically showing how the main program in a service system in accordance with the teaching of the present invention interacts indirectly with its storage subsystem for information access;

FIG. 3 is a flowchart illustrating the process flow implementing the conventional method for providing simultaneous services to multiple users;

FIG. 4 is a flowchart illustrating the process flow implementing the method in accordance with a preferred embodiment of the present invention for providing simultaneous I/O access services to multiple users;

FIG. 5 is a flowchart illustrating the process flow implemented by an I/O access agent that can be incorporated in the process flow of FIG. 4 in accordance with a preferred embodiment of the present invention;

FIG. 6 is a simplified block diagram schematically illustrating the system configuration of an I/O access agent subsystem in accordance with a preferred embodiment of the present invention for providing expanded service capability; and

FIG. 7 is a simplified block diagram schematically illustrating the system configuration of another I/O access agent subsystem in accordance with an embodiment of the present invention for providing game information service in an on-line game service system.

### DETAILED DESCRIPTION OF THE INVENTION

In the core processing section of modern computer systems, the advancements in microprocessor technology has been tremendous. Compared to the 16-bit microprocessor operating at 4.77 MHz clock rate in IBM's first personal computers, the microprocessor has evolved into ones with 32 even 64-bit data-path widths operating at clock rates faster than 1 GHz and processing instructions in multiple pipelines. The performance has improved more than two, even three, orders of magnitude. However, during the same period of time, the magnetic disk drive technology, although having comparable improvements in the disk storage density as well as overall storage capacity, has not been improved comparably in data access time due to inherent mechanical limitations in the disk read-write head mechanism. Frequently, such mechanical limitations in disk storage data access time comprise bottlenecks in the processing of information in computer systems. This is particularly true in applications involving the processing of multimedia information which requires vast amounts of audio and/or video data.

The method and system of the present invention fully exploit the processing power of modern microprocessors in order to improve overall system performance of an information service system provided over a WAN such as Internet. The method and system of the present invention achieve this by effectively discarding or, in other words, making use the waiting periods associated with the file accesses to the service information storage subsystem initiated by the users from over the WAN. A simplified block diagram for such a system implementing the method of the present invention is depicted in FIG. 2.

As is illustrated, the information service system 200 is set up to provide information service for multiple users 271, 272, . . . and 279 connected over the WAN 260 via a communication channel 250, preferably a broad-band channel. In one specific application, the information service system 200 can be used as the server system for an on-line game company. In such an application, game players 271, 272, . . . and 279 scattered remotely over the WAN 260 can connect to the system 200 in order to participate interactively in a complex and fascinating game.

The information service system 200 suitable for such applications may comprise a user interface 210, a main program 220, a service information storage subsystem 240, and an I/O access agent 230, which stands between the main program 220 and the storage subsystem 240. Note, as is comprehensible for those in the art, that more functional blocks and/or modules such as that responsible for controlling log-in and service fee charging functionality against a large number of simultaneous users are not shown in the block diagram. Since such functionality are not directly related to the disclosure of the present invention, they can be considered, for example, to be grossly included in the main program 220 of the system.

Also note that the constituent component blocks 210, 220, 230 and 240 in the system 200 of FIG. 2 may be conceptually envisioned as blocks of software modules or hardware logic circuit modules. Both are suitably applicable for the description of the method and system of the present invention in the broad sense.

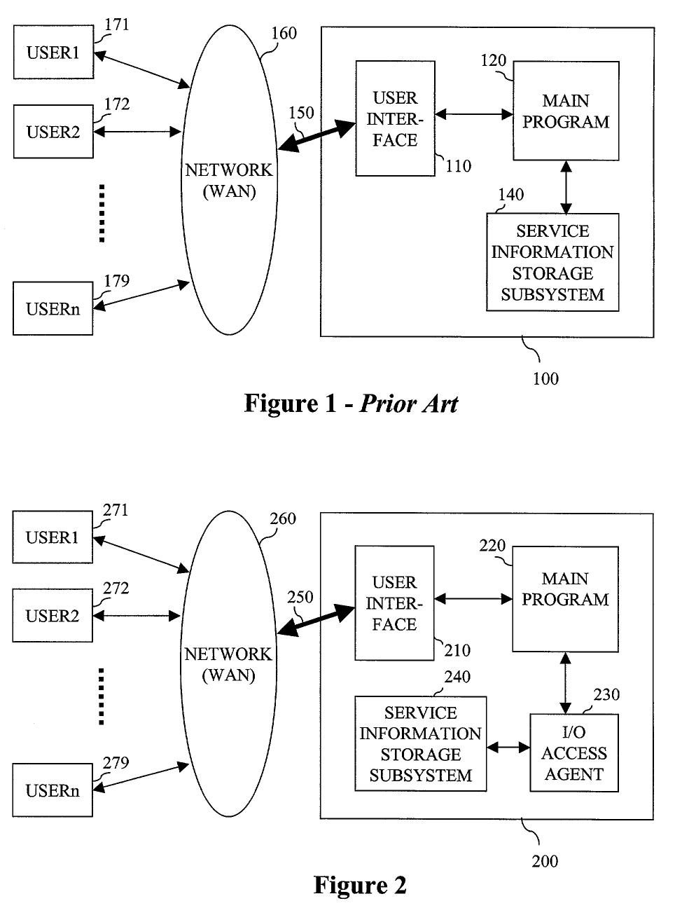

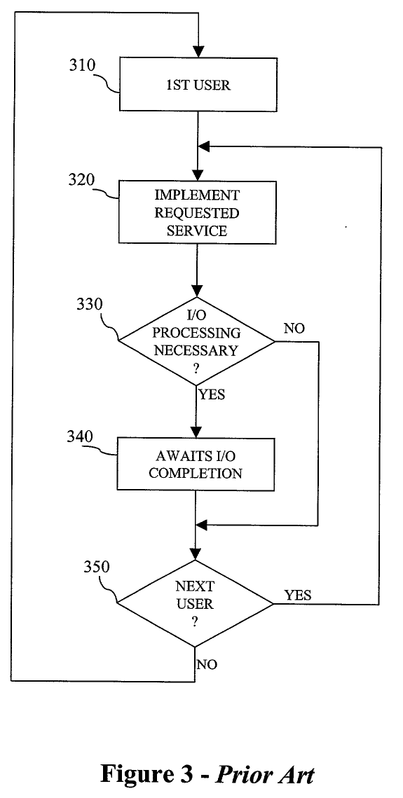

Unlike in the prior-art system of FIG. 1, in which the main program 120 issues information access requests directly to the service information storage subsystem 140, the information service system 200 of the present invention as depicted in FIG. 2 employs a different and indirect approach. As any one or more of the remote users 271, 272 . . . and 279 issues the information access request for either reading or writing a large amount of information out of or into the storage subsystem via the user interface 210, the main program 220 issues the corresponding access request to the storage subsystem 240 indirectly through the I/O access agent 230.

When the I/O access agent 230 acknowledges its acceptance of an information access request in the storage subsystem 240 issued by the main program 220, the agent 230, instead of requesting the storage subsystem 240 to perform an immediate access and waits for the completion of the I/O access, records the request in a cycling list in the first place. In a typical example, all the information access requests as issued by the main program 220 are entered into a plain cycling list in an order determined by the order of occurrence of each of the requests. A cyclically-repeating routine performed by the I/O access agent 230 that scans through all the entries in the record list submits each of the requests to the service information storage subsystem 240 for actually accessing the information.

After the I/O access agent 230 accepts and records an information request that asks for specific information in the storage subsystem 240, but before the agent 230 actually receives the request result from the storage subsystem 240, the main program 220 is allowed to proceed with its processing of providing service for fulfilling the other requests of other users logged into the system 200. In other words, it is absolutely unnecessary for the main program 220 to suspend all its activities simply to wait for the conclusion of an on-going information access in the storage subsystem 240.

As the I/O access agent 230 cycles back to the same request in the cycling list, a status flag signifying the conclusion of information access in the storage subsystem 240 is checked for its flag status. If the flag status indicates that the sometimes-lengthy information access has not yet been concluded, the cycling routine proceeds to the next request instead of waiting for its conclusion. This cycling routine is repeated over and over again and, in the process, each of the requests awaits its conclusion. Once a specific request for information access is fulfilled as its flag status is checked to be set, its entry in the cycling list can then be removed.

As the name implies, the I/O access agent 230 functions as an agent for receiving and managing I/O requests issued by various users from over the WAN 260. The agent 230 passes the requests on to the storage subsystem 240 of the service system 200 in a managed manner. When processing of a requested I/O is concluded by the storage subsystem 240, the agent 230 then returns the result of the requested I/O back to the specific requesting user, i.e. one of users 271, 272, . . . and 279. The I/O access agent 230 performs its tasks of managing the reception of incoming I/O requests and issuing of outgoing I/O results in a continuous program loop. In the process, each I/O access request received by the agent 230 is passed on to the storage subsystem 240 and then processing of the subsequent request continues without holding on the program execution to wait for the current access results.

In such a scheme, each requesting user gets rapid program attention as hosted by the main program 220 even though the access results of any other users are still on the way and are not yet available. I/O access agent 230 does not pause and wait for any specific I/O request results to come up from the storage subsystem 240 and stalls the entire request reception routine.

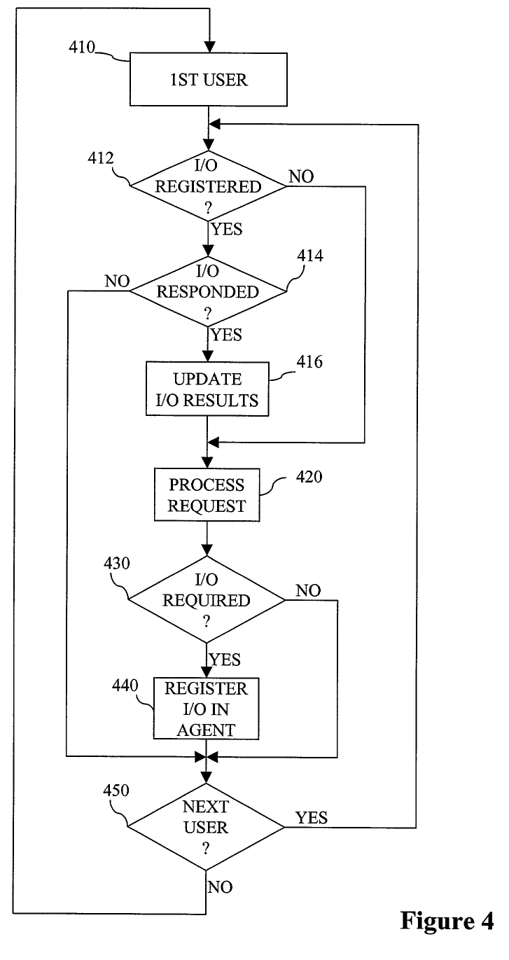

FIG. 4 is a flowchart illustrating the process flow implementing the above-described method in accordance with a preferred embodiment of the present invention for providing simultaneous I/O access services to multiple users. As described above, the main program (220 in FIG. 2) of an information service system (200) operates a repeating program loop for providing information access service to a number of users (271, 272, . . . and 279) connected across a WAN (260). In an embodiment as outlined in the program flowchart illustrated in FIG. 4, the program loop executed by the main program (220) of the service system (200) initiates for a first I/O access-requesting user at step 410. It should be noted that the program loop can be set up to cycle through all the received users requesting for I/O access service as recorded by the I/O access agent (230).

In general, in a most straight-forward approach, the looping can be set up in a scheme that is based on the simple principle of first-come first-serve. In an embodiment, each new user requesting for I/O access service can be added to a list maintained by the I/O access agent (230). All users in the service list are then scanned through in subsequent program cycles. However, as is comprehensible for those skilled in the art, weighted service loops are also possible. For example, those I/O requests posting longer time in the service loop may be allowed promoted priority to enjoy relatively more frequent status checks than those newly-posted ones. Or, those I/O access service requests asking for certain pre-categorized critical information may be allowed to enjoy higher frequency of status checks than others. This is to ensure that certain application-critical I/O accesses get more attention than those that are not as critical and therefore have a better opportunity of being completed as soon as possible.

After the program is initiated at step 410 for the processing of the request brought up by the first user in the list, program flow then proceeds to step 412 to check if the request has been registered as one for an I/O access. A negative test result of step 412 signifies the fact that the process request of the first user is non-I/O. The program flow may thus be transferred to step 420 for actually and directly performing this non-I/O request for the user. If, on the other hand, the test result of step 412 shows that the user's request is indeed one for information I/O, the program can then be advanced to step 414 to further check if the I/O requests has been submitted for processing and yielded a result from the information storage subsystem. If the accessed result has become ready, program flow may then be advanced to step 416 to update the I/O result and further proceeds to step 420 so that the main program may substantiate the user's request by issuing the accessed I/O result back to the user.

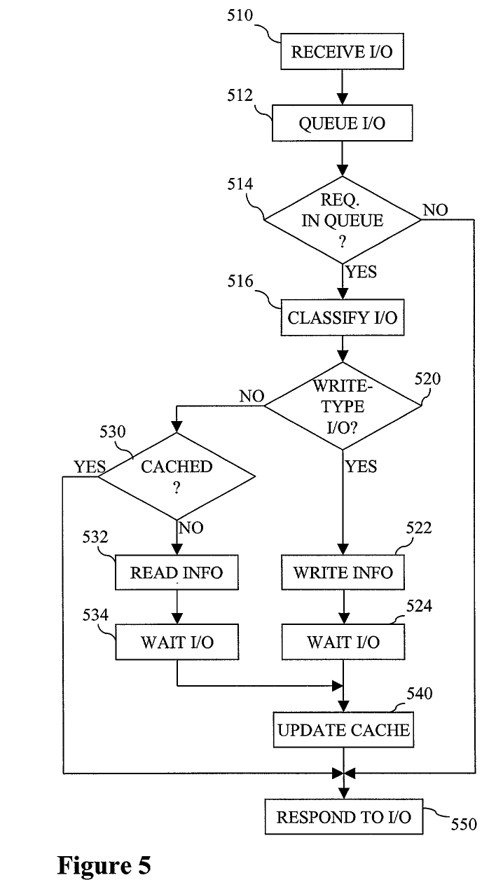

At this moment when the processing of step 420 is concluded, the program flow can be advanced to step 430, where the necessity of actually submitting for an I/O access is checked. If step 430 determines that there is no such need, the process flow that handles the current user's request can be concluded and program flow passed on to step 450. If, however, step 430 decides that the current user request is indeed a pending I/O access, the program flow can then be advanced to step 440, where an I/O access as implemented by the service information storage subsystem of the system of the present invention can be engaged via the I/O access agent. When this is concluded and the targeted I/O result becomes ready, the program flow is then ready to be concluded for the current user being processed. The program flow then proceeds to step 450, whose operation is described in detail in the following paragraphs. Note, however, that the processing details in step 440 are explained with reference to FIG. 5 of the drawing.

Meanwhile, if the test step 414 determines that the user's I/O request has not yet yielded its result, program flow may then be transferred to step 450, where the main program of the system checks to see if another user has come up to request for service. If there is a second user already waiting in the list and requesting for another service to be processed by the system, the program flow is transferred back to step 412 to see if this second user's request is I/O-related, and the program flow continues in the process as described above. If, on the other hand, no subsequent user with his or her request is waiting to be processed at this moment, the main program is transferred back to step 410, where the processing restarts from the first user in the list.

Thus, if the program flow at step 450 determines that there are second, third and further more users waiting in the list to be processed, the program flow may be restarted from step 412 for each of the waiting users in order to fulfill their respective requested I/O processing. If the last user in the list has been reached, the program flow may be returned back to process the first user in the list, and the flow of FIG. 4 can be repeated in another cycle.

Here, notice that if a user's requested I/O processing has not been concluded when tested in step 414, program flow of the main program module of the system is just skipped to the next user in its program loop instead of being halted to wait for the requested result to come up. Thus, the processing power of the system is not wasted in idling processor cycles waiting for the slow I/O to conclude. Instead, the processing power of the system can be directed to other tasks waiting to be processed.

FIG. 5 is a flowchart illustrating the process flow implemented by the I/O access agent (230 of FIG. 2) that can be incorporated in the process flow of FIG. 4 in accordance with a preferred embodiment of the present invention. In FIG. 4, when the program processing flow is transferred to step 440 based on the positive test result of step 430, the I/O access agent comes into play so as to substantiate service to the I/O access request for the requesting user.

In order to substantiate the I/O access, the program flow starts at step 510 of FIG. 5 as the I/O access agent accepts an I/O request issued by the user, whose request is being processed by the main program as is described above in FIG. 4. As the I/O access agent accepts the I/O access request at step 510, the program flow then proceeds to step 512 so as to register the very access request in the I/O process queue.

Then, step 514 checks to see if the I/O process queue maintained by the system is empty. A negative test result of step 514 indicates that there is at least one or more pending I/O access requests still waiting to be processed, and the program flow proceeds to step 516 in order to decide the type of the pending I/O access request. Then, in step 520, the I/O request is discriminated into either a read or a write request. For a read request, the program flow proceeds to step 530. For a write, the program transfers to step 522.

In case of a read-type I/O request, the program flow checks at step 530 to see if the information to be read-requested has already been present in the cache area of the storage subsystem. A recent previous read access to the same piece of information leaves a cache record in the storage subsystem. Such caches improve system overall performance effectively. If a cache record is indeed in existence, the program flow can be transferred to step 550, where the accessed information can be readily relayed back to the requesting user directly from the cache, and the program flow can be concluded for this particular read I/O request.

On the other hand, if the read-requested information is, unfortunately, not cached, the program flow proceeds to step 532, where the requested information is actually located in the storage subsystem and needs to be retrieved. The program then waits for the retrieval of the target information to be concluded at step 534. Once concluded, program flow goes to step 540 and updates the read cache of the storage subsystem. Then, the read-type I/O request can be concluded at step 550 as described above.

In case of a write-type I/O request, the program flow proceeds from step 520 to 522, where the information provided by the user and asked to be written into the storage subsystem of the information service system is actually written. Then, as the program flow concludes the writing at step 524, the program flow can then be advanced to step 540, where the cache of the storage subsystem can be updated. At this moment, the write-type I/O access request is concluded, and the program flow can then be transferred to step 550 to conclude the processing as described above. Note here that once the program flow of FIG. 5 is concluded at step 550, the system control can be transferred from the I/O access agent back to the main program.

Meanwhile, if the previous checking step 514 decides that the I/O process queue of the system has been emptied, meaning that all pending I/O requests have already been fulfilled by their respective results. The program flow can thus be transferred from step 514 directly to step 550 in order to conclude the I/O access agent's current cycle of job as outlined in FIG. 5. All requested results can be sent to the corresponding request-issuing users.

If an information service system is required to provide simultaneous service to a vast number of users, the inventive system and method as described above can be expanded to meet the requirement. In such an expanded system, a number of I/O access agents such as agent 230 described in FIGS. 2, 4 and 5 can be integrated to make up an I/O access agent subsystem for the service. Such an I/O access agent subsystem can be organized to be able to interface a storage equipment comprising a number of storage devices.

This can be achieved, for example, by organizing all the individual I/O access agents in the agent subsystem according to types of information to be accessed by all the users. Also, a number of main program modules can be set up in the information service system to share the system service load. If, in accordance with different predetermined criteria, the I/O requests issued by the users are organized into a number of different types, an I/O access agent subsystem can be set up between a main program subsystem and a storage subsystem having a number of organized storage devices. Parallel service processing can thus be achieved in a large information service system of the present invention.

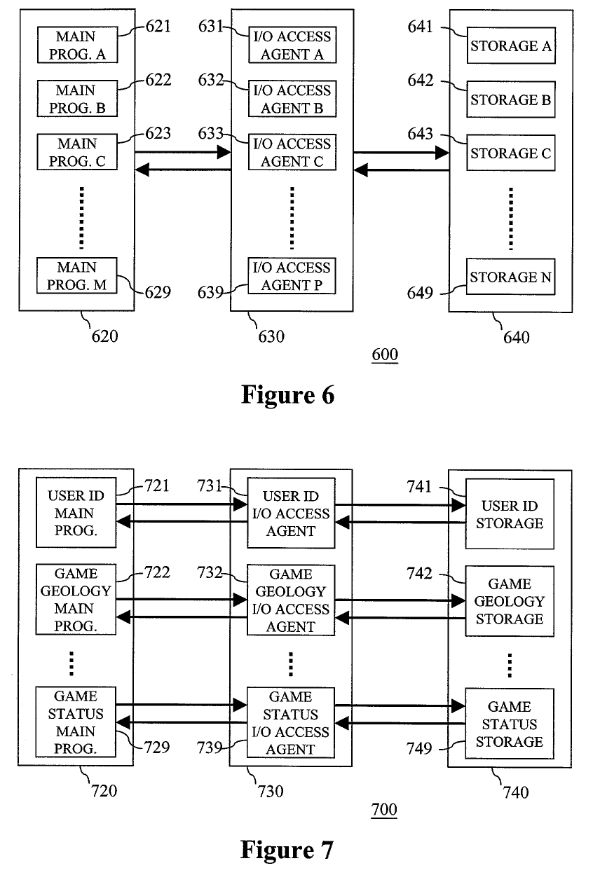

FIG. 6 is a simplified block diagram schematically illustrating the configuration of an information service system 600 comprising an expanded I/O access agent subsystem 630 in accordance with a preferred embodiment of the present invention. The access agent subsystem 630 comprising of one or more I/O access agents is set up between the main program subsystem 620 and the storage subsystem 640 of the service system 600. The main program subsystem 620 may also be a construction made up of a number of main program modules 621, 622, . . . 629. The storage subsystem 640, on the other hand, may be one with a number of storage devices 641, 642, . . . and 649. Such are main program and storage subsystems suitable for providing expanded service capability.

As an example, consider the situation in which the service system 600 of FIG. 6 is utilized in an on-line game service. As mentioned above, the multiple number of I/O access agents 731, 732, . . . and 739 of the I/O access agent subsystem 730 of the system 700 of FIG. 7 can be divided among different types of I/O access activities organized according to a pre-determined rule. For example, the I/O access agent 731 in the subsystem 730 can be assigned to be responsible for handling I/O accesses relating to user identification information. Likewise, agent 732 can be responsible for participating game players' information accesses categorized in accordance with geological territories in the virtual game world. Further, agent 739 can be responsible for user accesses with regard to user game status.

In the described embodiment of FIG. 7, each of the main program subsystem 720 and the storage subsystem 740 can be constructed to a structural configuration similar to that of the I/O access agent subsystem 730. For example, the main program module 721 in subsystem 720 can be set up to process users' I/O access requests in relation to user ID information. Main program module 721 may submit its I/O access requests received from game players to the corresponding I/O access agent 731 in subsystem 730. Similarly, a dedicated storage device 741 in the storage subsystem 740 can be assigned for the storage of user ID-related information for all registered game players of the service.

Note that the block diagram of FIG. 7 shows one single-block 741 for the storage of user ID information. However, as is comprehensible, a storage device 741 in subsystem 740 may be one single disk drive subsystem, or it may be a cluster of several server machines connected to a local area network if the user database is huge to be handled by a single server. Nonetheless, all storage devices in the subsystem 740 are integrated as a whole. This is much like how all the I/O access agents in the subsystem 730 and all the main program modules in the subsystem 720 are respectively integrated and organized for concerted operation in the service system 700 for hosting an on-line game service business.

Thus, the system and method of interruption-free file access as disclosed by this invention can be summarized to the principle of “let those have to wait keep waiting and allow those not need to wait keep going unaffected,” which is a concept of non-blocking I/O. The system and method of the present invention are also suitable for expansion along with growing service requirements employing measures such as categorized and dispersed I/O processing among a large array of storage devices. Service system overall operating efficiency is therefore optimized.

In the prior art, a multiple-thread operating system is likely to be dragged into sluggishness whenever certain I/O-intensive processing thread is submitted. Such I/O-intensive threads inevitably compromise the performance of other non-I/O-intensive threads processed in the OS. Other threads under the OS requiring I/O service may sometimes be stalled completely.

However, if the system and method of the present invention are applied in a multiple-thread OS, those I/O-intensive threads will be deprived of their CPU attention temporarily. In other words, an I/O-intensive thread is forced to relinquish its CPU control temporarily so as to pass CPU control over to other threads under the OS. An I/O-intensive thread surrendered its CPU control temporarily will only be re-assigned CPU control when its I/O access result is ready. Whenever after the I/O access result is ready, the thread may continue and conclude. During the period in which the I/O-intensive thread waits for its results, the OS is not dragged slow since the CPU is free to service all other threads under the OS.

By contrast, a prior art single-thread OS will be stalled completely whenever an I/O-intensive service is undertaken by the OS. Software routines such as one that services a multiple number of software clients will be stalled until an on-going I/O service is concluded. During this period, OS service to all other clients is virtually stopped.

If, however, the system and method the present invention are applied in a single-thread OS, this stalling can be avoided. The software system employing the inventive method receives an I/O-intensive service request, puts it into a control list and engages processing for the request, and then go on to service other software requirements instead of waiting for the time-consuming I/O service to conclude. This frees up the CPU from the tying-down of idling and waiting for implementing services to other requirements in the system. The only one put to wait is the I/O-intensive service request itself.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An information service system for providing interruption-free information access service to a plurality of users communicating to said system via a communications network, said system comprising:
a main program subsystem executing a main program for providing said information access service to said users by receiving I/O access requests issued by said users;
an information storage subsystem for storing information required for implementing said information service; and
an I/O access agent subsystem processing said I/O access requests issued by said users by registering said requests received by said main program subsystem and submitting said received requests to said information storage subsystem for implementing the read or write accesses corresponding to said requests, said I/O access agent subsystem relaying the result of said requests to said main program subsystem for returning to said users upon completion of said submitted requests.

2. The information service system of claim 1, wherein said information storage subsystem comprises at least one information storage means integrated for providing information storage functionality as a whole for said information service.

3. The information service system of claim 2, wherein each of said at least one information storage means is a disk-based storage device.

4. The information service system of claim 2, wherein each of said at least one information storage means is an information storage server.

5. The information service system of claim 2, wherein each of said at least one information storage means is a server cluster including at least one server connected in a local area network.

6. The information service system of claim 1, wherein said I/O access agent subsystem comprises at least an I/O access agent module integrated for implementing said registering and submission of said requests as a whole for said information service.

7. The information service system of claim 1, wherein said main program subsystem comprises at least a main program module integrated for receiving said I/O access requests issued by said users as a whole for said information service.

8. An on-line game information service system for providing interruption-free game information access service to a plurality of game players communicating to said system via Internet, said system comprising:
a main program subsystem executing a main program for providing said game information access service to said players by receiving I/O access requests issued by said players;
an information storage subsystem for storing game information required for implementing said game information service; and
an I/O access agent subsystem processing said I/O access requests issued by said players by registering said requests received by said main program subsystem and submitting said received requests to said game information storage subsystem for implementing the read or write accesses corresponding to said requests, said I/O access agent subsystem relaying the result of said requests to said main program subsystem for returning to said players upon completion of said submitted requests.

9. The on-line game information service system of claim 8, wherein said information storage subsystem comprises at least one information storage means integrated for providing information storage functionality as a whole for said information service.

10. The on-line game information service system of claim 9, wherein each of said at least one information storage means is a disk-based storage device.

11. The on-line game information service system of claim 9, wherein each of said at least one information storage means is an information storage server.

12. The on-line game information service system of claim 8, wherein each of said at least one information storage means is a server cluster including at least one server connected in a local area network.

13. The on-line game information service system of claim 9, wherein one of said at least one information storage means stores player identification information for said game information service system.

14. The on-line game information service system of claim 9, wherein one of said at least one information storage means stores game virtual geological information for said game information service system.

15. The on-line game information service system of claim 9, wherein one of said at least one information storage means stores game player game status information for said game information service system.

16. The on-line game information service system of claim 8, wherein said I/O access agent subsystem comprises at least an I/O access agent module integrated for implementing said registering and submission of said requests as a whole for said information service.

17. The on-line game information service system of claim 8, wherein said main program subsystem comprises at least a main program module integrated for providing said game information access service to said as a whole for said information service.

18. The on-line game information service system of claim 16, wherein one of said at least one I/O access agent module implementing said registering and submission of said requests in relation to game player identification information for said game information service system.

19. The on-line game information service system of claim 16, wherein one of said at least one I/O access agent module implementing said registering and submission of said requests in relation to game virtual geological information for said game information service system.

20. The on-line game information service system of claim 16, wherein one of said at least one I/O access agent module implementing said registering and submission of said requests in relation to game player game status information for said game information service system.

21. The on-line game information service system of claim 17, wherein said main program subsystem comprises at least a main program module integrated for receiving said I/O access requests issued by said users as a whole for said information service.

22. The on-line game information service system of claim 21, wherein one of said at least one main program module implementing said receiving of said requests in relation to game player identification information for said game information service system.

23. The on-line game information service system of claim 21, wherein one of said at least one main program module implementing said receiving of said requests in relation to game virtual geological information for said game information service system.

24. The on-line game information service system of claim 21, wherein one of said at least one main program module implementing said receiving of said requests in relation to game player game status information for said game information service system.

25. A method for providing interruption-free file access service to users communicating to an information service via a communications network in an information service system comprising a main program subsystem, an information storage subsystem and an I/O access agent subsystem, said method comprising the steps of:
a) said main program subsystem registering information access requests issued by said users in a list and submitting said requests to said I/O access agent subsystem;
b) said I/O access agent subsystem submitting said requests issued by said users to the information subsystem for implementing read or write accesses corresponding to said requests; and
c) said I/O access agent subsystem relaying the result of said requests to said main program subsystem for returning to said users upon completion of access of said submitted requests by said information storage subsystem, wherein said information service system continuing said information service for said users before said completion of an I/O access that is pending.

26. A method for providing interruption-free file access service to game players communicating to an on-line game information service via Internet in an on-line game information service system comprising a main program subsystem, an information storage subsystem and an I/O access agent subsystem, said method comprising the steps of:
a) said main program subsystem registering information access requests issued by said game players in a list and submitting said requests to said I/O access agent subsystem;
b) said I/O access agent subsystem submitting said requests issued by said game players to the information subsystem for implementing read or write accesses corresponding to said requests; and
c) said I/O access agent subsystem relaying the result of said requests to said main program subsystem for returning to said game players upon completion of access of said submitted requests by said information storage subsystem, wherein said on-line game information service system continuing said on-line game information service for said game players before said completion of an I/O access that is pending.
